(19) United States
(12) Patent Application Publication
(10) Pub. No.: US 2009/0077163 A1
(43) Pub. Date: Mar. 19, 2009

(54) Approach for identifying and providing targeted content to a network client with reduced impact to the service provider

(75) Inventors: Kent Thomas Ertugrul, London (GB); Anton Roslov, London (GB)

Correspondence Address: ALLEMAN HALL MCCOY RUSSELL & TUTTLE LLP, 806 SW BROADWAY, SUITE 600, PORTLAND, OR, 97205-3335, US

(73) Assignee: Phorm UK, Inc., London (GB)

(21) Appl. No.: 11/901,255

(22) Filed: Sep. 14, 2007

(51) Int. Cl. G06F 15/16; G06Q 30/00

(52) U.S. Cl. 709/203; 705/14

(57) ABSTRACT

A client network is provided, whereby an internet service provider can anonymously acquire behavioral, contextual, and/or demographic information on a client specific basis. The behavioral information may include a historical digest of network activity by the client, such as webpages visited by the client user, content downloaded to the client device, and/or information requested by the client user. The contextual information may include a representation of the current state of the client, such as the most recent webpages loaded by the client browser as well as the content associated with these webpages. As one example, the anonymously acquired client information may be used to enable the delivery of customized content to the client, such as targeted advertising.

### BACKGROUND AND TECHNICAL FIELD

The Internet provides client users with access to a wide range of content, services and products. This facility allows users to interact with each other in ways not available to older media and new methods of content delivery are evolving to exploit this potential. The present disclosure is directed to targeted content delivery whether it be provided via the Internet or other suitable data network.

### BRIEF DESCRIPTION OF THE DRAWINGS

FIG. 1 shows a schematic depiction of a first embodiment of an example client network.

FIG. 2 shows a flow chart illustrating an example control routine for the network of FIG. 1.

FIG. 3 shows a schematic depiction of a second embodiment of an example client network.

FIG. 4 shows a flow chart illustrating an example control routine for the network of FIG. 3.

FIG. 5 shows a schematic depiction of a third embodiment of an example client network.

FIG. 6 shows a flow chart illustrating an example control routine for the network of FIG. 5.

FIG. 7 shows a schematic depiction of an example profile for a client of the network as stored at the ISP server system.

FIG. 8 shows a schematic depiction of an example advertisement selection process as performed by the channel server.

FIG. 9 shows a schematic depiction of an example heuristics based approach that may be utilized by the various embodiments described herein.

### DETAILED DESCRIPTION

The following disclosure provides several example embodiments of a client network, whereby a service provider or more specifically an internet service provider (ISP) or other third parties can anonymously acquire client information including behavioral, contextual, and/or demographic information on a client specific basis via the ISP infrastructure. The behavioral information may include a historical digest of the client's network activity, including webpages visited by the client user, content downloaded to the client device, and/or information requested by the client user, among others. The contextual information may include a representation of the current state of the client, such as the most recent webpages loaded by the client browser as well as the content associated with these webpages. The demographic information may include information associated with the particular geographic region where the client resides, the type of ISP service used by the client, and the type of client device, among others.

As one example, the anonymously acquired client information may be used to enable the delivery of targeted advertising content to the client. As another example, the acquired client information may be used by the ISP or other third parties to identify or indicate specific subsets of clients while maintaining client specific anonymity. In this way, it may be possible to identify and categorize groups of clients of the entire client population based on their respective network interactions. By maintaining client anonymity, the client's privacy may be preserved, while also enabling the ISP or other third parties to identify and access select specific subsets of clients based upon their behavioral and contextual state as obtained via the ISP infrastructure. In each of these embodiments, the impact on the data flow through the ISP infrastructure may be reduced or eliminated, thereby reducing network latency, increasing network redundancy, and increasing the rate of adoption among service providers of the various approaches described herein.

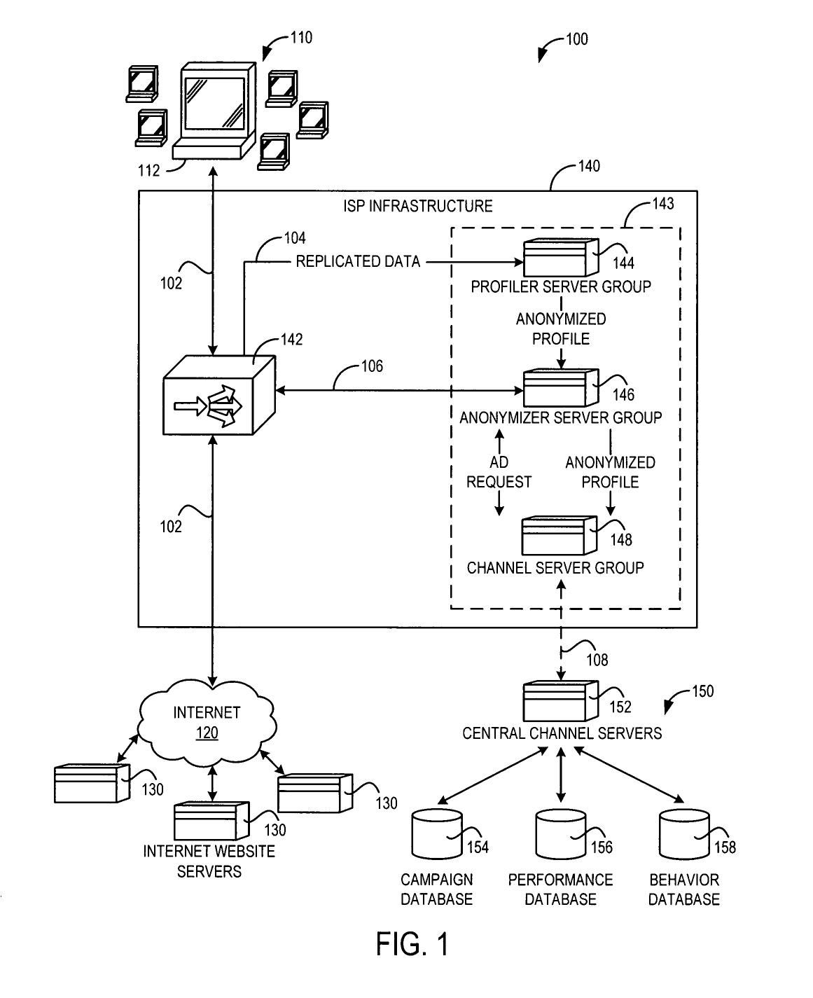

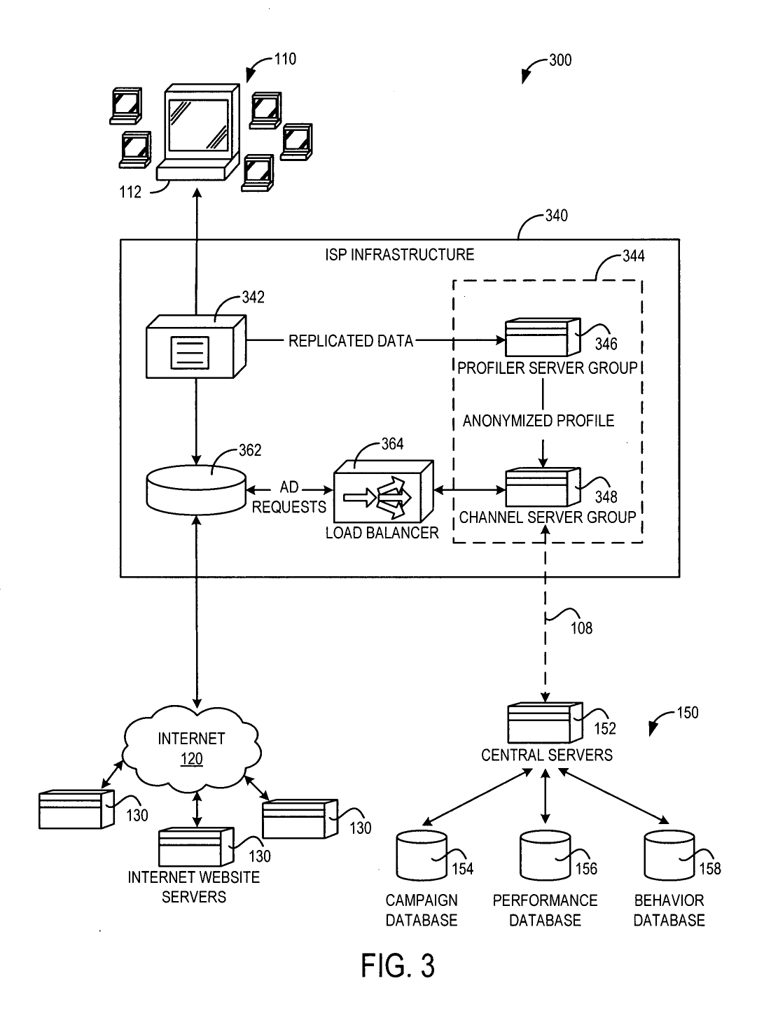

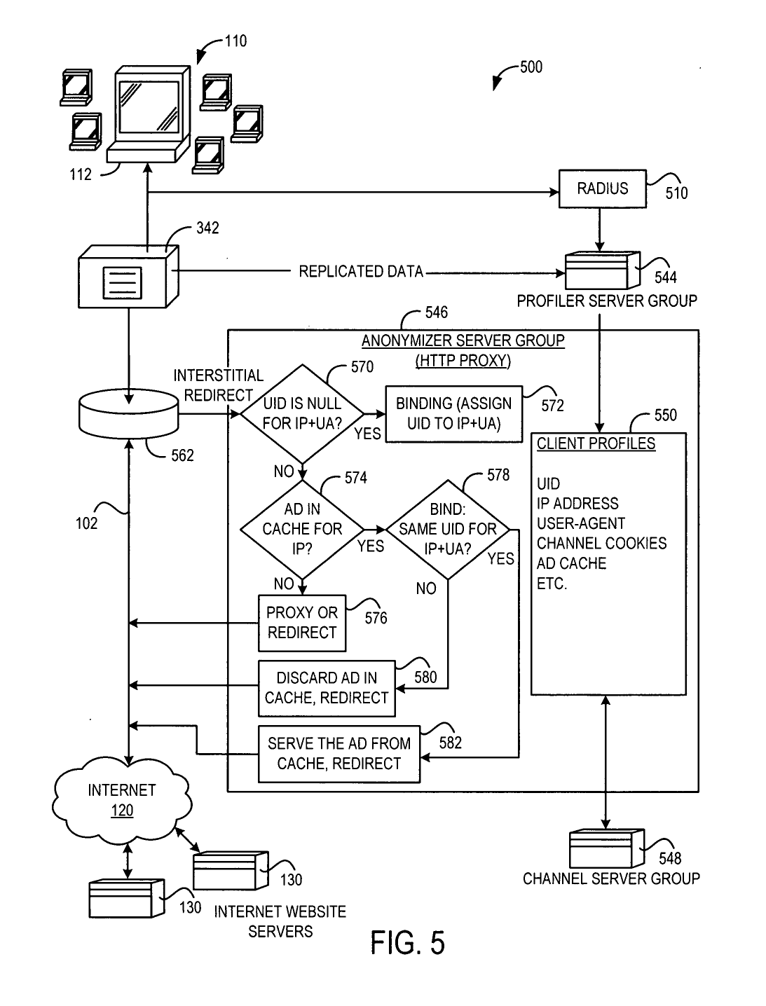

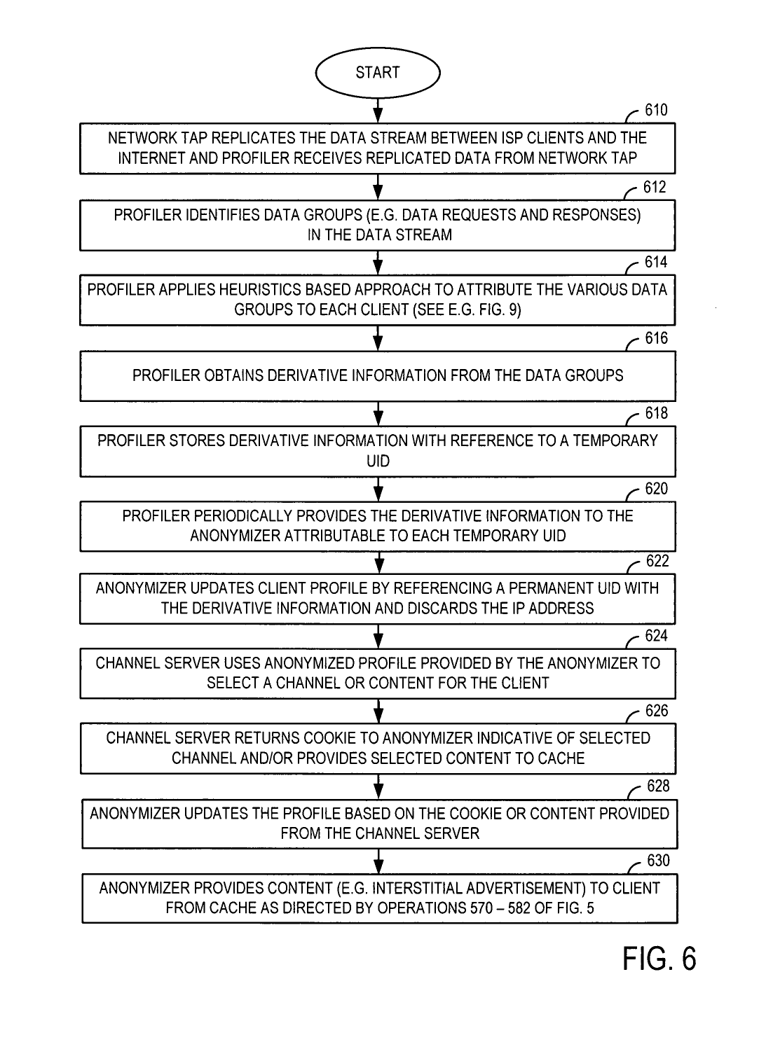

As a first embodiment, shown schematically in FIG. 1, an ISP server system may selectively receive data transferred between the client and a WAN via a switching device. The second embodiment, shown in FIG. 3, illustrates how the ISP server system can be configured to receive and analyze data that is replicated from the original data stream, thereby enabling acquisition of client specific information including behavioral and contextual information without increasing system latency. The third embodiment, shown in FIG. 5, provides an approach whereby system latency may be reduced with regards to the implementation of the first embodiment, while also providing the ISP with greater client interaction than permitted by the second embodiment. For example, the third embodiment may be used to permit the placement of interstitial advertisements between domain transitions. While the various approaches provided herein have been described with reference to one of three embodiments, it should be appreciated that these approaches may be interchanged with and applied to each of these embodiments.

FIG. 1 shows a schematic depiction of the first embodiment of an example client network 100. Network 100 may include a plurality of client devices 110 communicating with one or more website servers indicated generally at 130 via the Internet 120 or other suitable wide area network (WAN). Each of the plurality of clients can exchange data with the Internet via an internet service provider (ISP) shown schematically at 140. As one non-limiting example, ISP 140 can facilitate the exchange of data between the clients and internet website servers via the Internet. As described herein, a client may include a computer, hand held device, television, or other suitable device for enabling a client user to communicate electronically with other client users or content providers via a wide area network such as the Internet.

As one example, a client user of a particular client 112 can interact with one or more Internet website servers over the course of a session by initiating webpage requests via the ISP. The client may include software such as a web browser that receives and requests data on behalf of the client and converts the response data into a webpage or other suitable graphical user interface that may be displayed to the client user via a display device of the client such as a display monitor. Over the course of a particular session, the client user may operate the client device via the browser to browse a plurality of webpages across a plurality of Internet domains and stored at one or more Internet website servers. In this way, a data stream between the clients and the Internet, indicated generally at 102, can enable an exchange of data via the ISP.

ISP 140 may include, among other elements, a switching device 142 configured to redirect selected portions of the data stream exchanged between the clients and the Internet to ISP server system 143. Switching device 142 may include one or more of a Layer-7 switch, a deep packet inspection device, a router, load balancing device, or other suitable device that may be configured to redirect select portions of data stream 102 to the ISP server system. As one non-limiting example, switching device 142 can be configured to redirect only Hypertext Transfer Protocol (HTTP) data designated on port 80 (or alternatively on port 81) to ISP server system 143 as indicated at 106. Note that ports 80 and 81 described herein are merely exemplary and refer to the current transport protocols used for communication between elements of a computer network via HTTP. Furthermore, in some examples, switching device 142 may be configured to provide data to the data stream from the ISP server system.

Server system 143 of ISP 140 may include one or more servers for analyzing and identifying select portions of the data stream attributable to a particular client (e.g. client 112) of the plurality of clients, and for selecting and returning targeted content (e.g. an advertisement) to the client responsive to the analysis of the portion of the data stream of which they are attributed. As one example shown in FIG. 1, ISP server system 143 may include at least a profiler 144, an anonymizer 146 including an HTTP proxy, and a channel server 148 for performing these and other operations described herein.

While ISP server system 143 is shown to include at least three separate server groups, it should be appreciated that in other examples, the profiler, anonymizer, and/or the channel servers may be configured as a single server or server group. Furthermore, the ISP infrastructure may include other servers or server systems besides server system 144 for providing other ISP related functionality or ISP server system 144 may perform other ISP related functionality in addition to the various approaches described herein. Switching device 142 may also be configured to provide load balancing between the various servers of a particular server group to balance the data load provided to each server of the group. The profiler, anonymizer, and channels server described herein with reference to the first embodiment can provide the same or similar functionality for the second and/or third embodiments described herein.

Additionally, in at least some examples, ISP server system 143 can selectively communicate with a centralized channel server system 150 residing external to the ISP infrastructure. Note that centralized channel server system 150 can also communicate with a plurality of other independent ISP server systems in addition to ISP 140 to enable centralized control and/or sharing of data among the plurality of ISPs. Centralized channel server system 150 can be administered by a moderator to enable interaction amongst a plurality of ISPs as well as other third parties. Thus, the moderator through centralized channel server system 150 can provide an administrative role for coordinating the selection and serving of tailored content to the various network clients of a plurality of different ISPs.

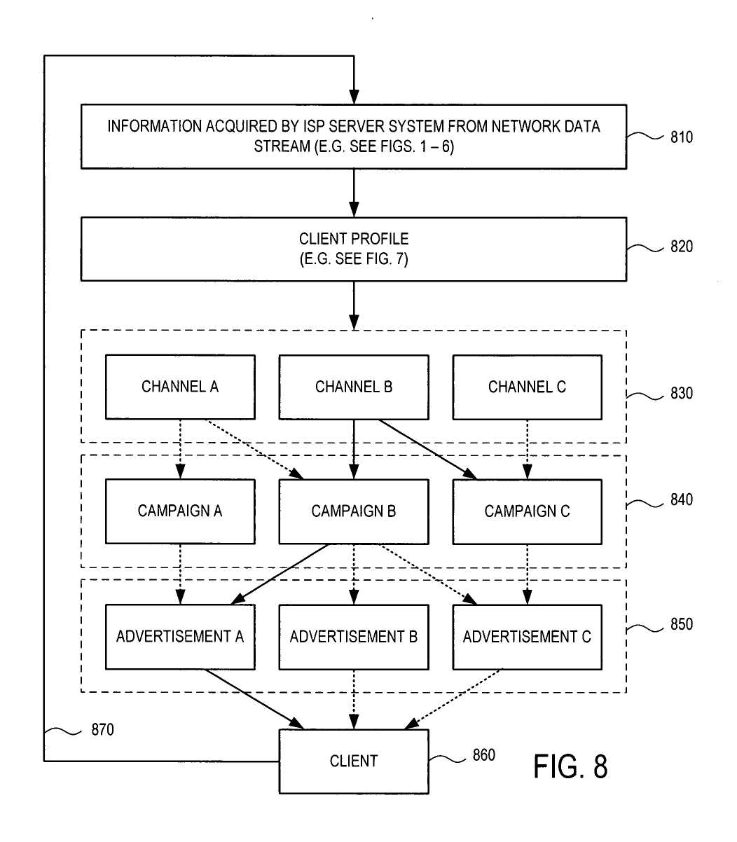

Centralized channel server system 150 may include one or more channel servers that each may include a campaign database 154, a channel performance database 156, and/or a behavioral information database 158 that will be described in greater detail herein. As one example, campaign database 154 can include a plurality of campaigns that indicate channels and/or associated content that may be provided to the ISPs, where the content can be in turn provided to the clients responsive to their network activity. As described with reference to FIG. 8, campaigns can include definable rules for the provision of content to the clients. Channel performance database 156 can include channel performance information that has been obtain from feedback indicative of the channels selected by channel server 148 residing at the ISP level for each of the plurality of ISPs with which the centralized channel server system 150 communicates. In this way, the ISP, moderator or other third party can identify which channels are more or less successful at being selected by the channel server 148 responsive to client network activity as well as evaluating the frequency at which particular content has been provided to the clients. Behavioral database 158 can receive feedback from each of the ISP server systems indicative of the client's response to the content as well as the derivative information that may be associated with each UID of the client pool. Thus, in at least some examples, the ISP, moderator or other third party can utilize the centralized channel server system 150 to identify the network behavior of the client population or a specific subset of the client population via their respective network activity across a plurality of different ISP interactions.

In this way, the ISP, moderator or other third party can collect accounting information, performance information, and/or behavioral information based on the content that is provided to the clients of ISP 140 as indicated at 108, where the information may be stored in one of databases 154, 156, and 158. The information obtained from client activity by a first ISP may be shared with other third parties including other independent ISPs, content providers, advertisers, marketers, or other suitable parties via centralized channel server system 150, where it may be used for purposes of research, billing, and/or system control.

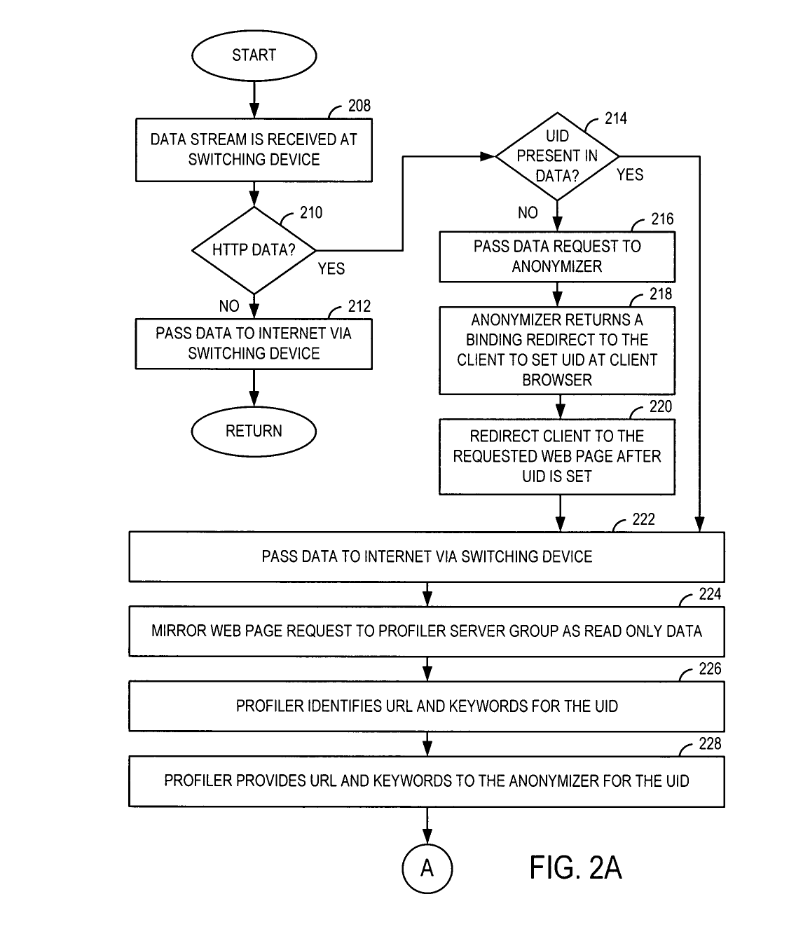

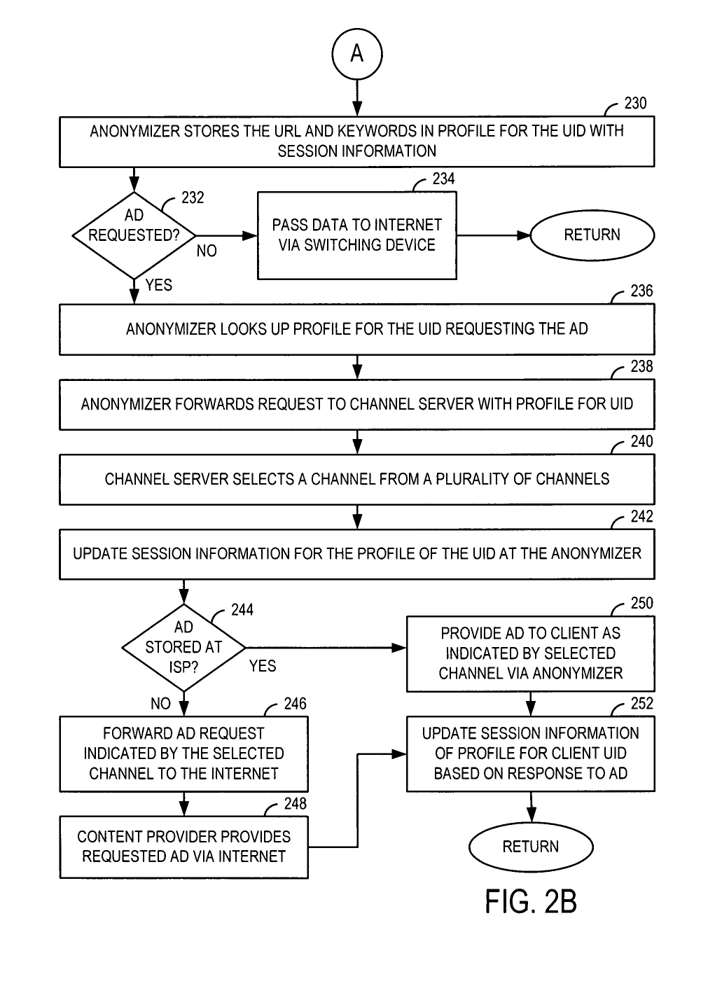

FIGS. 2A and 2B show a flow chart illustrating an example method for providing content to a specific network client based upon the client's behavioral and contextual information acquired by the ISP based on the client's network activity. The various flow charts provided herein can represent control routines that may be performed via hardware instructions, software instructions, or a combination thereof. It should be appreciated that the various operations described herein and represented schematically via the accompanying flow charts are exemplary. Thus, some of the operations described herein may be at times performed in an alternative order or may be omitted, and may include additional operations not expressly depicted by the flow charts.

Data transferred between client 112 and internet 120 may be received and identified at switching device 142 of ISP 140 as indicated at 208. As one example, client 112 may request a webpage from an Internet website server 130 by way of an HTTP request on port 80 as indicated at 102. Note that the data may also include HTTP response data from the Internet website server to the client via the Internet. If at 210 the data stream passing through switching device 142 does not include HTTP data, then the data stream may be passed to the Internet by the switching device at 212, whereby the routine may return. In this way, non-HTTP data may be passed through the switching device without being redirected to the ISP server system.

Alternatively, if the data includes HTTP data, for example, on port 80, then the routine may proceed to 214. Note that in some examples, the data stream passing through switching device 142 may include an assortment of HTTP and non-HTTP data, whereby the switching device may be configured to pass all non-HTTP data to the Internet, while redirecting select HTTP data to the ISP server system. As described herein, non-HTTP data may include HTTPS data among other protocols designated on port 80 or 81, and protocols designated on ports other than 80 and 81.

As indicated at 214, if the HTTP data received at the switching device does not include the unique identifier or identification (UID) tag, then the HTTP data may be passed to the anonymizer server via the switching device at 216 as indicated by 106. The anonymizer server may then return a binding redirect at 218 (e.g. via a proxy located at the anonymizer) that sets a master UID tag at the client browser, a process that may be referred to as binding. As one non-limiting example, the master UID tag may be set at the browser by a Layer-3 redirect or other suitable Open Systems Interconnection (OSI) based model.

As one example, the anonymizer server can send a cookie to the client browser that causes each HTTP data request issued by the client to include a copy of the master UID tag. After the master UID tag is set at the client browser, as indicated at 220, the anonymizer can forward the HTTP data to the Internet (e.g. via a proxy), whereby the requested data is in turn provided to the client. Note that each client of the plurality of clients communicating with the Internet via the ISP can be referenced in this manner by each being assigned a different UID tag. As one example, the UID tag assigned to each client may include a randomly generated and unique identifier. For example, each client may be assigned an associated UID that is not indicative of their respective IP address. In this way, a particular client may not be identified by the UID for purposes of determining the identity of the client user, thereby maintaining the client's privacy during the acquisition of their network activity.

Once the master UID tag is set at the client browser, subsequent browsing of webpages by the client user generates HTTP data requests, which include copies of the master UID tag that can be identified by the switching device. As one example, the anonymizer proxy can be configured to redirect the client's browser to the binding feature that re-writes the webpage with a master UID tag (e.g. cookie) when the client enters a new web domain in order to set the UID tag for each webpage associated with the domain.

If the UID tag is present in the HTTP data, at 222, the HTTP data may be passed to the Internet and a read-only copy of the HTTP data including the UID tag may be provided to the profiler server group by the switching device at 224. In this way, the switching device can be operated to redirect the HTTP data stream between the client and the Internet to the ISP server system only when the UID tag is not present in the HTTP. Thus, network latency may be reduced by redirecting the data stream in order to set the master UID tag only when the client user transitions to a new domain.

At 226, the profiler identifies certain derivative information from the HTTP data for the associated UID tag. As one non-limiting example, the profiler can identify the Uniform Resource Locator (URL) associated with the HTTP data, keywords contained in the HTTP data, and/or search queries initiated by the client user. For example, Hypertext Markup Language (HTML) contained in the HTTP data may be analyzed by the profiler server, whereby certain keywords are identified and/or counted. In some examples, the profiler may identify only select keywords as specified by the ISP, moderator, or other third party. For example, the profiler may be configured to identify the frequency of select keywords or types of keywords contained in the HTTP data and/or may be configured to ignore specified keywords or types of keywords. As one non-limiting example, the profiler can explicitly ignore data received from form fields of webpages, email addresses, and/or numbers containing more than a prescribed quantity of digits (e.g. ignore numbers with four or more digits). As another non-limiting example, the profiler can compile a list of the most common, relevant keywords in the webpages requested by the client browser. Furthermore, the profiler can rank the keywords contained on the requested webpage based on their frequency (e.g. number of occurrences) on each of the requested webpages and/or the density of keywords in a particular portion of text on the webpages.

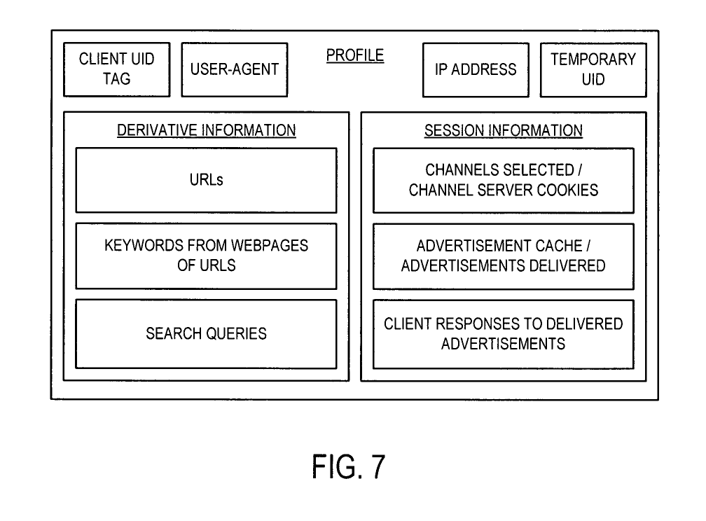

At 228, the profiler can provide a digest of information including the derivative information obtained from the HTTP data with the associated UID to the anonymizer. At 230, the derivative information can be stored at the anonymizer in a profile database for each of the associated UIDs. An example profile is described in greater detail with reference to FIG. 7. As one example, the anonymizer can create a profile for each new UID that is received and update the appropriate profile for each existing UID in response to derivative information obtained from the network activity of the UID by the profiler. This digest of information, including the derivative information, can be asynchronously provided to the anonymizer by the profiler with each HTTP data request (e.g. for each webpage loaded or requested by the browser). Alternatively, the derivative information can be provided to the anonymizer server in a synchronous manner with the HTTP data requests. Further still, the profiler can provide the derivative information to the anonymizer server in response to each data group or quanta attributable to the client, or may be provided after a plurality of data requests and/or responses that are attributed to the client. For example, for each webpage viewed by the client, the profiler can asynchronously send a channel request to the channel server via the anonymizer. When making this request, the anonymizer can discard any non-anonymous identifiers such as the client's IP address, to maintain client anonymity.

As the client user browses the Internet by requesting and receiving webpages via HTTP data exchanged between the client and Internet website servers, content including advertisements may be delivered to the client as directed by advertisement request tags embedded within the webpages. For example, HTTP data associated with the webpage including at least one advertisement request tag may be received at the switching device. Where the advertisement request tag is addressed to the ISP server system, the switching device provides the advertisement request to the anonymizer. Alternatively, the advertisement or other content request can be provided to the ISP server system by a different routing device. As indicated at 232, if the HTTP data includes the advertisement request tag addressed to the ISP, the routine may proceed to 236. Alternatively, if the advertisement tag is addressed to another location communicating with the client via the Internet, then the switching device can pass the advertisement request to the Internet as indicated at 234.

At 236, the anonymizer server receives the advertisement request including the UID tag associated with the client, and looks up the profile for the client requesting the advertisement based on the corresponding UID. At 238, the anonymizer server forwards the advertisement request to the channel server with the profile for the appropriate UID. Note that the anonymizer can discard select information from the profile before forwarding the profile to the channel server. For example, the anonymizer can discard the non-anonymous identifiers, such as the IP address of the client, to maintain anonymity.

At 240, the channel server selects a channel from a plurality of channels stored at the channel server group. As described herein, a channel may include a set of rules that may be referred to as triggering conditions or triggering criteria that may be satisfied to enable the channel to be selected by the channel server. As one example, each channel can indicate content such as one or more advertisements that can be provided to the client upon selection of the channel as described in greater detail with reference to FIG. 8. More specifically, each channel can indicate an advertising campaign that has its own set of rules for governing the frequency at which an advertisement is provided to a client, the number of advertisements that may be provided, and the type of advertisements that may be provided, among other rules that enable an advertiser to control the provision of advertising content to a client user. These and other operating parameters of the ISP server system can be adjusted by the ISP, moderator, or other third party via the centralized channel server system. Regardless of the particular configuration of the channel, each channel can indicate at least one advertisement or other suitable content.

As another example, a channel may be used to indicate a particular subset of clients from the client population. The ISP server system can be used to identify a particular subset of the client population that has activated a particular channel in response to their respective network activity. For example, the ISP, moderator, or other suitable third party (e.g. as permitted by the moderator) can utilize the central channel server to perform a search of all the UIDs of the ISP or central channel server database that have activated a particular channel or that have been served with particular content, whereby the central channel server can return the relevant list of UIDs. However, since each of the UIDs and their corresponding profile information have been anonymized by the ISP server system (e.g. via the anonymizer or profiler) by discarding the non-anonymous information (e.g. IP address), the identity of these clients can remain anonymous.

In this way, a channel can serve as a powerful market research tool to provide the ISP, moderator, or other third party including content providers, marketers and advertisers, with the ability to identify specific client subsets whose network activity satisfies the triggering conditions or rules associated with a particular channel. By enabling the ISP, moderator, or other third parties to anonymously identify clients that have activated a particular channel or that have been served particular content, these clients can be subsequently provided with content that is of higher relevance.

The channel server can select a channel from the plurality of channels by comparing the profile provided by the anonymizer server with the triggering conditions associated with each channel. As shown in greater detail in FIG. 7, the profile may include, in addition to the derivative information, associated session information that indicates past advertisements that have been provided to the client and/or the client's response to those advertisements. The channel server can utilize this profile information to activate the triggering conditions associated with each of the channels, whereby the channel having the greatest number of activated triggering conditions or the greatest number of activated triggering conditions relative to other channels may be selected by the channel server.

At 242 the channel server provides the selected channel to the anonymizer, where the anonymizer can update the session information stored in the profile based on the selected channel. For example, the anonymizer can update the session information at the profile for the advertisement provided to the client or to be provided to the client as indicated by the selected channel. The channel server can also update the profile with a cookie that indicates the selected channel, for example, as referenced by a channel identifier. As yet another example, the channel server can cause the anonymizer to store content such as an advertisement in a cache of the profile for later deployment to the client.

It should be appreciated that the anonymizer need not wait for an advertisement or other content request to be provided to the ISP server system before the anonymizer provides profile information to the channel server for the selection of content. For example, the anonymizer can provide content to the client that has been selected by the channel server prior to receiving the advertisement or other content request.

Referring to 244, if the advertisement is stored locally at the ISP server system, for example, at the channel server group or within the ISP server system, the advertisement may be provided to the client at 250, as indicated by the selected channel via the anonymizer. As each channel may indicate one or more advertisements to be delivered to the client, the session information stored in the profile database may be updated by the anonymizer for the particular advertisement that was actually provided to the client, for example, as directed by the campaign rules associated with the channel.

Alternatively, if the advertisement is not stored locally at the ISP server system, the anonymizer server can forward a request for the advertisement indicated by the selected channel to the appropriate content provider via the Internet as indicated at 246. At 248, the content provider provides the requested advertisement to the client via the Internet, whereby the client browser can display the advertisement to the client user as directed by the webpage and associated advertisement tag. For example, the advertisement can be provided in the appropriate advertising slot on the webpage.

Regardless of the originating location of the advertisement, at 252, the anonymizer can update the session information of the profile database based on the client user's response to the advertisement. For example, where the client user selects the advertisement (e.g. by click or interacting with the advertisement), a corresponding HTTP request may be initiated that can be passed to the anonymizer server via the switching device. The anonymizer server can update the session information to indicate the client's response to the advertisement. For example, the anonymizer can store information at the profile that indicates whether the advertisement successfully induced the client user to request additional information in response to the advertisement. As one example, the profiler server may identify HTTP data attributed to the client user selecting the advertisement, and provide information indicative of the client's response to the anonymizer server via the profiler, where it may be stored at the client's profile. In turn, the updated profile may be used to guide the channel server in selecting additional advertisements to be delivered to the particular client in response to a subsequent advertisement request. Finally, the routine may return, for example, to 208, whereby the data stream may be again assessed for HTTP data including an associated UID tag.

The first embodiment described herein with reference to FIGS. 1 and 2 can reduce the extent and frequency of redirection of the data stream between the client and the Internet via the ISP by redirecting the data stream to the ISP server system only for HTTP data that does not include a UID tag. By utilizing a master UID tag that is provided to the client browser only upon domain transitions, the added latency of the network may be reduced. Furthermore, the first embodiment may be used to maintain client anonymity when obtaining behavioral and contextual information of the client by utilizing a randomly assigned UID for each client rather than non-anonymous information such as the IP address or login name of the client. The reduced impact to the data stream can provide an advantage to some service providers that seek to minimize redirection of the data stream via their server system. Furthermore, since only select data is redirected from the data stream via the switching device, a failure of the ISP server system may cause only limited or reduced disruption of the network.

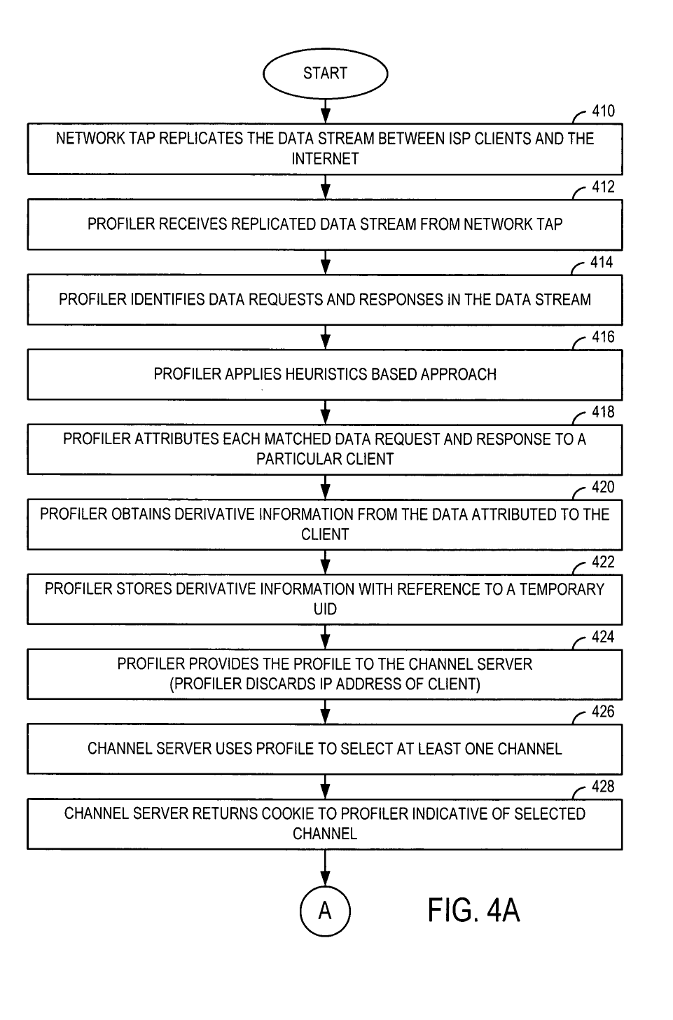

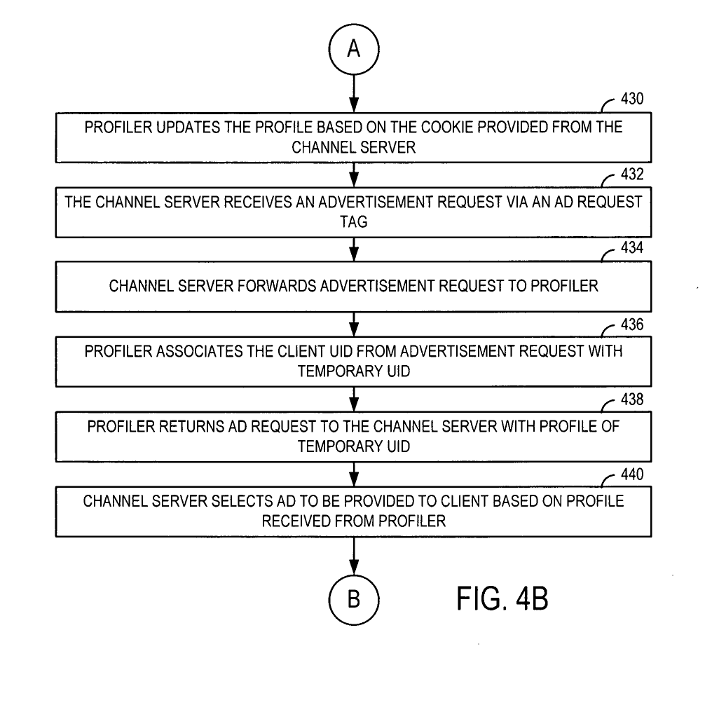

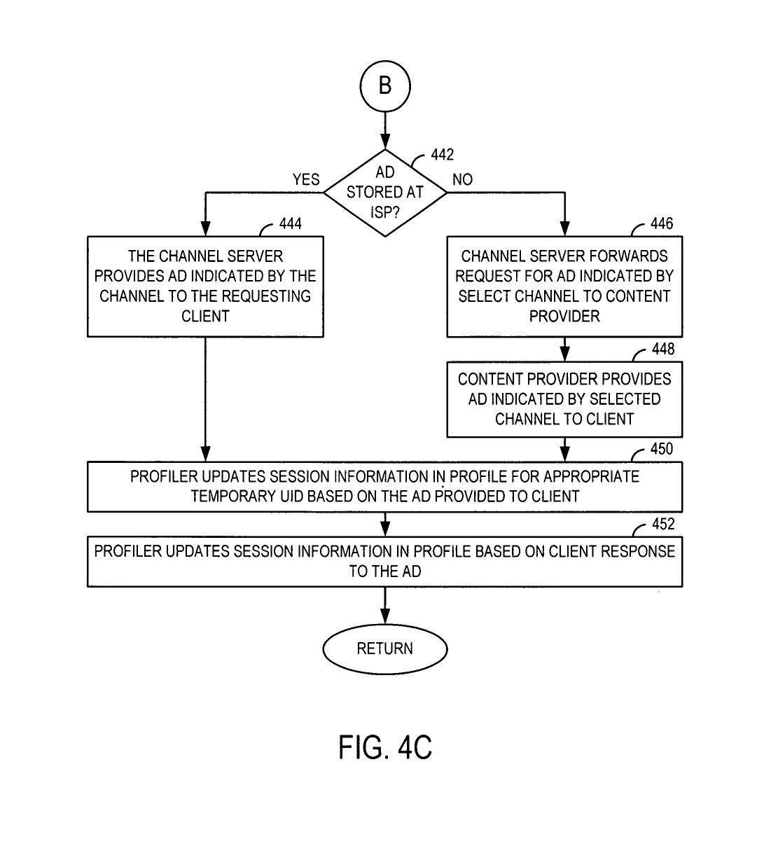

Referring now to FIGS. 3 and 4, a second embodiment of a client network is described, which can provide some of the same advantages as the first embodiment, as well as additional advantages including reduced network latency. FIG. 3 shows a schematic depiction of the second embodiment of an example client network 300. Network 300 is similar to network 100 of the first embodiment in many respects. For example, network 300 can include a plurality of clients 100 communicating with Internet website servers indicated generally at 130 via the Internet or other suitable WAN. However, network 300 in this example includes an ISP 340 having a different configuration and/or functionality than ISP 140 of network 100. For example, with the second embodiment, ISP 340 may utilize a data replicating device such as a network tap 342 that is configured to replicate network traffic between the clients of the ISP and the Internet or Internet website servers. Referring also to FIG. 4, at 410, the network tap can replicate the data stream between clients 110 and the Internet 120. As one example, a particular client 112 can request a webpage from Internet website servers 130 by way of an HTTP data request. At 412, the replicated data stream (e.g. the HTTP data request) can be provided to the ISP server system 344 by the network tap.

In this particular embodiment, ISP server system 344 includes a profiler server group 346 and a channel server group 348. Note that in other examples, the functions respectively performed by the profiler server group and the channel server group may be alternatively performed via a single server or server group. Thus, it should be appreciated that where the profiler or channel server are referenced, a similar function may be performed by a group of servers or a single server to enable some or all of the features described herein. Furthermore, the ISP infrastructure may include other server systems besides server system 344 for providing other ISP related functionality or the ISP server system 344 may perform other ISP related functionality in addition to the various approaches described herein.

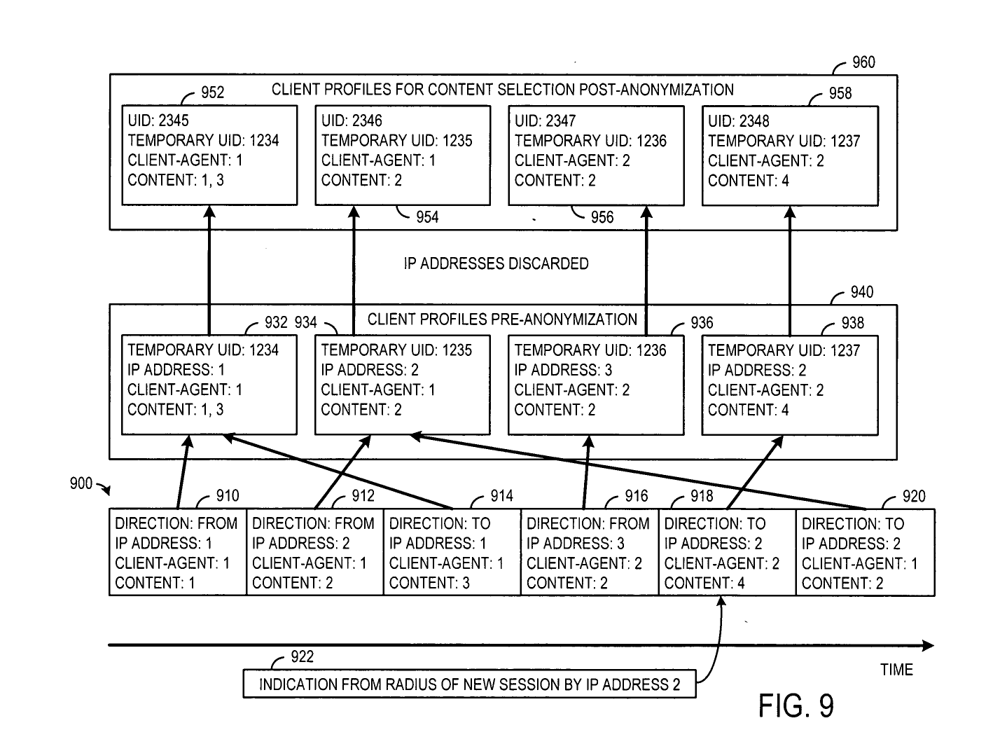

The replicated data stream can be provided to the profiler from the network tap, for example, while the original data stream proceeds uninterrupted between the clients and the Internet. In this way, network latency may be reduced as compared to the first embodiment, since acquisition of the data and client identification does not affect the original data stream. Instead, the profiler in the second embodiment and also in the third embodiment shown in FIG. 5 can utilize what may be referred to as a heuristics based approach to identify which portion of the data stream is attributable to a particular client of the service provider, by examining the copy or replicated version of the data stream. This heuristics based approach is described in greater detail with reference to FIG. 9.

Briefly, as one example of a heuristics based approach, the profiler server can compare IP addresses, user-agent information, browsing patterns, etc. associated with each of a plurality of data requests or data responses to client information stored in the client profiles. When the profiler identifies a new IP address, it can assign or associate a new temporary UID with the new IP address and accompanying user-agent information. User-agent information as described herein can include the type and/or version of the client's browser and/or operating system as may be detected by the ISP.

As the profiler receives one or more subsequent data requests or data responses attributable to the IP address (e.g. either as the source or the target of the data request or response), the profiler server can distinguish multiple clients or client users utilizing the same or different IP addresses based on a comparison of their browsing behavior (e.g. matching data requests with data responses) and/or client-agent information. For example, the network activity of two clients utilizing the same IP address can be distinguished from each other when the clients utilize different browsers or different operating systems. As another example, when the network activity associated with a particular IP address that exhibits incongruous browsing behavior, then the profiler may infer that a second client or new client is using the same IP address. For each new client that is identified, the profiler can assign a temporary UID to derivative information that is obtained from the portion of the data stream attributable to the client.

Further, as shown in FIG. 5, the profiler server can receive information from a Remote Authentication Dial In User Service (RADIUS) that may be used to distinguish different client users that utilize the same client device or same IP address based upon their authentication with the network and/or ISP. In some examples, the first and/or second embodiments described herein may utilize input from a RADIUS as described with reference to FIG. 5 to further assist the ISP to differentiate the network activity of multiple clients.

As indicated at 414, the profiler can identify data groups including data requests and/or responses exchanged between a group of clients and the Internet via the ISP. At 416, the profiler applies the heuristics based approach to the various data groups. These data groups can then be attributed to a particular client at 418. As the portion of the data attributed to the network activity of each client is identified using the heuristics based approach, the ISP server system can obtain derivative information from the data stream at 420 for each client. For example, the profiler server group can analyze the replicated data to identify the URL associated with each data request or response, keywords displayed on webpages requested by or provided to the client as described with reference to 226 of the first embodiment, and/or search queries initiated by the client. In contrast to the function performed by the profiler in the first embodiment, profiler server group 346 is configured to create profile for the client without redirecting the data stream.

At 422, the derivative information attributed to a particular client can be stored in a profile for the client by assigning the client a temporary UID. In contrast to the UID tag provided to the profiler in the first embodiment, the temporary UID may be instead assigned to the data attributed to the particular client without reading the UID tag directly from the data stream. Thus, the profiler server can periodically create and update the profile for a particular client with information derived from the portion of the data attributed to the particular client with reference to the assigned temporary UID.

As the client continues to request and receive data over their network session, the profiler can provide the profile to the channel server system as indicated at 424. Note that in some examples, the profiler can discard the IP address of client as will be described in greater detail with reference to FIG. 9, thereby anonymizing the profile. In this way, the profiler of the second embodiment can perform at least some of the functionality of the anonymizer of the first and third embodiments. In turn, at 426, the channel server system can utilize the profile provided by the profiler to select at least one channel from the channel database. As described with reference to the first embodiment, each channel of the channel database may include one or more associated triggering conditions that are activated in response to information contained in the profile. The selection of advertising content or other suitable content via one or more channels is described in greater detail with reference to FIG. 8.

At 428, the channel server can then return updated session information (e.g. a cookie or state object) indicative of the selected channel or selected content (e.g. advertisement) to the profiler. In other examples, the channel server can return the actual content such as an advertisement, which can be stored in a cache at the profiler from which it may be later provided to the client. At 430, the profiler can update the profile for the temporary UID based on the updated session information received from the channel server and/or selected content.

As the client continues to request and receive data such as webpages from the Internet via the ISP, some of these webpages may include one or more advertisement request tags. As one non-limiting example, the moderator or ISP may have established a relationship with webpage publishers to enable targeted advertising to be shown on webpages accessible via the publisher's website. For example, the client user can encounter an advertisement request tag addressing the ISP on any suitable webpage where the publisher has enabled the advertisement tag. The advertisement tag can be configured to request an advertisement from the ISP server system.

For example, at 432, the advertisement request tag can initiate an advertisement request to the channel server domain of the ISP, whereby the channel server can forward the request to the profiler server at 434. The advertisement request can include a client UID, which is different from the temporary UID assigned to the client by the profiler server. As one example, the publisher of the webpage may introduce the client UID to the client browser in the form of a cookie upon visiting their website or domain. Thereafter, the client's browser may be tagged with the client UID. As another example, the channel server can set the client UID at the client browser (e.g. via cookie) the first time an advertisement is sent to the client from the channel server. In this way, the advertisement or other content that is provided to the client from the ISP can include a UID tag that causes the client's browser to provide the ISP with the UID for each subsequent data request.

At 436, the profiler can associate the client UID included with the advertisement request with the temporary UID assigned to the replicated data attributed to the client. The profiler server can also add session information stored in the profile to the advertisement request. At 438, the profiler server can then return the advertisement request to the channel server with the up to date session information for the client.

At 440, upon receiving the advertising request from the profiler server with the associated session information of the client, the channel server can select an advertisement to be delivered to the client. As one non-limiting example, the channel server can reference at least one of two databases. As described with reference to FIG. 8, a campaign database stored at the channel server can contain the available advertising campaigns including their revenue rates, advertising rules such as frequency thresholds for specifying how frequently the client may be provided with a particular advertisement within a specified time period, and targeting rules specifying, for example, which clients are permitted to receive the advertisements. A behavioral database stored in a profile at the channel server can contain the longer term behavioral profile of the client UID (e.g. network activity and advertisement response information, etc.), in contrast to the shorter term profile compiled by the profiler server with reference to the temporary UID.

The channel server can compare the information received from the profiler server for the client, where it may be compared to the database in order to select an advertisement. As one example, the channel server may be configured to return the highest earning advertisement that is valid in light of the advertising rules set forth in the campaign database for the particular content of the webpage displayed to the client user. FIG. 8 provides further description of the advertisement selection process that may be performed by the channel server.

As a result of the selected advertisement, at 444, the channel server can supply the advertisement to be shown in the advertisement slot on the webpage. For example, the channel server can generate the appropriate HTML or JavaScript code of the advertisement. Alternatively, where the advertisement is stored external to the ISP server system as judged at 442, the channel server may forward a request for the selected advertisement to a content provider located external to the ISP, as indicated at 446, whereby the advertisement may be provided to the client from the content provider as indicated at 448. For example, the content provider may include an internet website server or other server communicating with the client via the Internet.

At 450, the channel server can update the longer term session information stored for the client in the profile at the channel database in response to the selected advertisement. For example, the channel server may update the number of advertisements remaining with reference to the frequency threshold of the advertising campaign. At 452, the profiler can update the session information at the profile based on the client response to the advertisement.

FIG. 5 shows a schematic depiction of a third embodiment of an example client network 500. Network 500 is similar to network 100 of the first embodiment and network 300 of the second embodiment in many respects. As described with reference to FIGS. 1-4, client 112 of a plurality of clients 110 associated with a service provider can communicate with one or more internet website servers 130 via Internet 120 or other suitable WAN. Network 500 may also include a data replicating device such as a network tap 342 described with reference to FIG. 3, which may be configured to replicate network traffic between the network clients and the Internet. Note that network tap 342 can also be located at the ISP level as shown in FIG. 3. Data that is replicated by network tap 342 can be provided to a profiler server group 544.

As one non-limiting example, profiler server group 544 may include one or more servers configured to perform some of the same functions described with reference to profiler server groups of the first and second embodiments. For example, profiler 544 can apply the heuristics based approach of the second embodiment to attribute portions of the data stream to a particular client as described in greater detail with reference to FIG. 9. Profiler 544 can also update a client profile for each of the clients as described with reference to the first and second embodiments.

Furthermore, in this example, profiler server group 544 can receive information from RADIUS 510 indicative of whether a new client or client user has requested access to the WAN (e.g. Internet) via the ISP. For example, RADIUS 510 can provide an indication to the profiler that a client is initiating a new session. As one non-limiting example, at the start of a session, the UID may be unknown for the IP address and/or user-agent that is identified by the profiler. Thus, the UID may be bound on the first domain transition performed by the client, wherein the UID is associated with the client's IP address and/or user-client at the profile. When the IP address is reallocated, for example, upon initiation of a new session by the client as identified by the profiler via input from the RADIUS, any profiles associated with the same IP address may be discarded from memory.

Furthermore, the RADIUS can be used by the profiler to distinguish different users of the same client device even when they utilize the same IP address by referencing the login name and/or password provided by each of the users, among other forms of identification including client-agent information. In turn, the profiler can utilize the input from the RADIUS to create a new profile and assign a new UID or temporary UID. It should be appreciated that the profilers of the first and second embodiments can also receive input from a RADIUS to assist in identifying when a client has initiated a new session. For example, profiler server group 346 can utilize input from a RADIUS when applying a heuristics based approach to associate the temporary UID and/or IP address with the UID at the channel server as described with reference to FIG. 9.

Profiler 544 can periodically provide profile information to anonymizer 546, which in this example may also include an HTTP proxy. For example, for each webpage viewed by the client, the profiler can asynchronously send a channel request to the channel server via the anonymizer. When making this request, the anonymizer can discard the client IP address. Alternatively, the IP address information can be discarded from the profile information by the profiler. The profile information including a temporary or permanent UID, IP address of the client and user agent, and derivative information among other parameters that is received from profiler 544 can be stored at the anonymizer's profile database 550. Furthermore, the anonymizer can obtain channel cookies and content including advertisements from channel server group 548 upon submission of the client profile as was previously described in each of the first and second embodiments.

The advertisements or other content can be stored in a cache (e.g. an advertisement cache) at profile database 550 where they may be served to the client under select conditions. Similarly, channel cookies indicating content to be delivered to the client, past content delivered to the client, or other content selection information can be obtained from channel server group 548 where they may be stored at profile database 550. It should be appreciated that the interaction between the profiler, anonymizer, and channel server can be the same or similar as those previous described with reference to the first and/or second embodiments.

The third embodiment provides at least some advantages over the second embodiment in that interstitial advertisements may be served to the client as the client transitions between Internet domains. For example, router or switching device 562 can be configured to redirect portions of the data stream to anonymizer server group 546 under select conditions. As one example, an interstitial redirect may be provided when an HTTP port 80 data request for a transition from a first domain to a second domain is requested and can be redirected to anonymizer server group 546 via router 562. As one non-limiting example, the UID may be bound on the first domain transition by the client after the initiation of a new session, whereby the client profile is initially created and populated with derivative information via the profiler. Some domain transitions may not be routed to the anonymizer, but may instead pass to the Internet when the requested file or URL extension matches a predefined term. For example, extensions that reference photographs or videos (e.g. gif, jpg, etc.) may be passed to the Internet without being redirected to the anonymizer.

As indicated at 570, if the UID associated with the domain transition request is null (e.g. unavailable) for the IP address and user-agent information, binding may be performed as indicated at 572, whereby the UID is assigned to or associated with the IP address and the user-agent information stored in the profile. For example, the anonymizer server group can identify whether the IP address and/or user-agent attributable to the domain transition request references a UID stored in the profile. If not, this association of the UID with the IP address and/or user-agent information can be stored at profile database 550 for the client that is associated with the domain transition request. Furthermore, this approach can be performed by the anonymizer server group for each of the plurality of clients 110 as they request domain transitions. As one example, the decision at 570 may be performed by way of a Layer-4 switch.

The HTTP proxy for the Anonymizer in first and third embodiments may include one or more of a Layer-4 software switch and a Layer-7 switch based on the Open Systems Interconnection (OSI) model. As one example, whereby the HTTP proxy operates on Layer-7 of the OSI model (Application Level) when the data stream is passed through the proxy, the HTTP connection may be terminated on the proxy, and the proxy can create a new HTTP connection to the end-user (e.g. client or other suitable destination). By contrast, a Layer-4 (Transmission Control Protocol (TCP) Level) proxy doesn't terminate on the HTTP level, but only on the TCP level, which can further reduce system latency as a new HTTP does not need to be made to the end-user.

Returning to 570, if the UID associated with the domain transition request is not null for the IP address and/or user-agent information attributable to the client associated with the request, then it may be judged whether content such as an interstitial advertisement is stored in the cache (e.g. advertisement cache) at the profile. If the advertisement or other content is stored in the cache for the IP address, then it may be judged whether to perform binding as indicated at 578. Binding in this example may include redirecting the client browser to a pre-selected domain where a UID cookie can be set at the browser such that future data attributed to the client includes the UID. This binding approach may be performed in a similar manner as described with reference to the first embodiment.

If the answer at 578 is no, the advertisement or other content stored in the cache for the UID may be discarded and the client may be redirected to the originally requested webpage. Alternatively, if the answer at 578 is yes, an interstitial advertisement or other content may be served to the client before the client is redirected to the originally requested webpage. Otherwise, if at 574 the advertisement or other content is not available from the cache, then the data request issued by the client and received from the data stream can be proxied, whereby the originally requested data is provided to the client. For example, the webpage that was originally requested by the client browser can be provided.

While not shown in FIG. 5, channel server group 548 can also communicate with a central channel server, as indicated by 150 in FIGS. 1 and 3. It should be appreciated that some or all of the various components described herein including the profiler, RADIUS, anonymizer, and channel server group can reside at the ISP level. As one example, the RADIUS, the profiler, anonymizer, and/or channel server group can comprise one or more servers and can be provided by a common ISP server or by a plurality of independent ISP servers.

FIG. 6 shows a flow chart illustrating an example control routine for the network of FIG. 5. At 610, the network tap replicates the data stream between the ISP's clients and the Internet and the profiler receives the replicated data from the network tap. At 612, the profiler identifies data groups in the data stream. For example, as described with reference to FIG. 9, the profiler can identify data requests and responses contained in the data stream. At 614, the profiler analyzes the data groups and applies a heuristics based approach to attribute the various data groups to each client of the network. As one example, the profiler can examine only a portion of the data stream such as HTML or HTTP data.

At 616, the profiler obtains derivative information from the data groups by analyzing the HTTP data for keywords, search queries, URL information, etc. At 618, the derivative information is stored with reference to a temporary UID as described in the second embodiment. At 620, the profiler periodically provides the derivative information to the anonymizer attributable to each temporary UID. The anonymizer then updates the client profile with the derivative information and discards the IP address from the profile, as indicated at 622. As one example, the profile can include both a permanent UID and a temporary UID, whereby the derivative information is matched with the permanent UID of the profile by referencing the temporary UID as described by FIG. 9. At 624, the channel server uses the anonymized profile (e.g. profile with IP address discarded) to select a channel or content for the client. Where the channel server selects a channel, the channel indicates content that may be provided to the client upon satisfaction of a triggering condition, as will be described with reference to FIG. 8. As one example, this content may include an interstitial advertisement to be provided to the client during a transition between a first domain and a second domain.

At 626, the channel server returns a cookie to the anonymizer indicative of the selected channel and/or provides selected content to the cache. At 628, the anonymizer updates the profile based on the cookie or content provided from the channel server. For example, the profile can be updated by replacing previously selected advertisements at the cache with newly selected advertisements as the client continues to browse the Internet. At 630, the anonymizer provides content such as interstitial advertisements to the client from the client's respective profile as directed by operations 570-582 of FIG. 5. For example, if there is an advertisement in the cache for the client's UID, the interstitial advertisement may be provided (i.e. served) to the client as indicated at 582. Otherwise, if the cache does not include an advertisement or other suitable content, then the client may be redirected to the originally requested webpage.

FIG. 7 shows a schematic depiction of an example profile for a particular client of the network as was described with reference to the various embodiments. The profile may include any suitable digest of information that is usable by the ISP server system for selecting targeting content to be delivered to the client. Depending on the particular embodiment, the profile may be identified with reference to the client's UID tag as provided by the randomly generated master UID tag set at the client browser and/or the temporary UID assigned to the client in the case where the profiler applies the heuristics based approach of the second and third embodiments. However, the temporary UID may be omitted from the profile in some examples, such as with the first embodiment described herein.

The profile may also include user-agent information such as information indicative of the client's browser (e.g. type and/or version) and client operating system (e.g. type and/or version). In some examples, the profile may include non-anonymous information such as the IP address of the client. For example, where the profile is in a pre-anonymized state, the IP address may be stored in the user profile. However, where the profile is in a post-anonymized state, the IP address may be discarded or omitted from the profile as described with reference to FIG. 9.

The profile may also include derivative information comprising the URLs of webpages visited by the client, keywords displayed on the webpages loaded by the client's browser, and search queries initiated by the client via internet searching websites, for example. This derivative information may be indicative of the client user's behavior as well as the context in which they are currently browsing. For example, keywords stored at the profile may be referenced based on frequency and/or density in which they occur on a given webpage, and may be stored with reference to the URL of the webpage by which they were provided to the client. Thus, it should be appreciated that the profile may include a listing of keywords associated with each URL visited by the client, enabling the channel server to identify the temporal history at which the keywords were provided to the client. Similarly, search queries initiated by the client may be used by the channel server to identify content to be later provided to the client.

The profile may also include session information comprising the channels that were selected by the channel server for the client or channel server cookies that are indicative of the selected channels, content stored in the content cache (e.g. advertisement cache) and/or advertisements previously delivered to the client, as well as client responses to the content. In some examples, each channel may be assigned a channel identifier, thereby enabling the corresponding identifier of each of the selected channels to be stored in the client's profile. Similarly, each item of advertisement or other content item may be assigned a unique identifier, thereby enabling the corresponding identifier for each of the advertisements that were selected for or delivered to the client to be stored at the profile. The client's response to an advertisement may also be stored at the profile with reference to the advertisement's identifier.

FIG. 8 shows a schematic depiction of how the ISP server system can select targeted content such as an advertisement for delivery to a particular client of the network. However, in other examples, a channel can be instead selected by the ISP server system in order to identify a particular subset of clients of the client population. As described with reference the embodiments provided herein, information acquired by the ISP server system from the network data stream, as indicated at 810, can be used to compile a client profile for a particular client as indicated at 820. The client profile may be used to select a channel from a plurality of channels indicated generally at 830.

As one example, a channel may be associated with one or more advertising campaigns indicated generally at 840. As indicated by the arrows connecting the channels with some of the advertising campaigns, channel A is associated with advertising campaigns A and B, in this particular example, while channel B is associated with advertising campaigns B and C, and channel C by contrast is associated with advertising campaign C. As can be appreciated from the example of FIG. 8, a channel may be associated with one or more campaigns and each campaign may be associated with one or more channels.

Similarly, a campaign may be associated with one or more advertisements indicated generally at 850. As indicated by the arrows connecting the campaigns with some of the advertisements, campaign A in this particular example is associated with advertisement A, while campaign B is associated with advertisements A, B, and C, and campaign C is associated with advertisement C. As can be appreciated from the example of FIG. 8, a campaign may be associated with one or more advertisements and each advertisement may be associated with one or more campaigns.

Regardless of the particular association of the channels, campaigns, and advertisements, each channel selected by the channel server can indicate at least one specific form of content to be provided to the client. With each of the embodiments described herein, the selection of channels may be governed by the activation of the specific set of triggering conditions associated with each channel. Thus, a channel may be made eligible for selection by the channel server by fulfilling some or all of the triggering conditions.

As one specific non-limiting example, a triggering condition for Channel B may require a particular keyword to be present on a webpage that is retrieved and loaded by the client browser at least a prescribed number of times before the channel is activated or selected by the channel server. The channel server can compare the triggering condition of a particular channel with the client's profile, which includes the various keywords or other derivative information obtained by the profiler. If the client has requested and/or received webpages that include the requisite number or frequency of keywords or other derivative information then the triggering condition of the channel may be satisfied. As another specific non-limiting example, a triggering condition for Channel A may include a prescribed URL address, whereby the triggering condition for Channel A is satisfied when the client browser has accessed the particular URL address.

In this particular example, channel B is selected from a group of channels 830 including channels A, B, and C as indicated by the solid arrow connecting channel B to the associated campaigns B and C. Since, channel B is associated with campaigns B and C, the selection of one of the campaigns may be governed by a set of rules unique to each campaign as well as a cost competition among the campaigns for their selection. For example, campaigns C may include a rule that prescribes a maximum price that will be paid for the campaign to be selected by the channel server, while campaign A may include a rule that prescribes a higher maximum price that will be paid. Note that these campaign rules may be prescribed by the ISP, moderator or other third party such as an advertiser, content provider, or advertisement campaign manager via the centralized channel server system indicated at 150.

In this particular example, campaign B was selected as the winning campaign as indicated by the solid arrow connecting campaign B to advertisement A. In turn, advertisement A may be selected from advertisements B and C that are also associated with the campaign as specified by the campaign rules specific to campaign B. For example, advertisement A may be selected by the channel server rather than advertisements B and C based on a maximum or minimum selection frequency for each advertisement specified by the campaign. In other words, a frequency threshold associated with advertisements B and C may have already been attained, thereby enabling advertisement A to instead be selected by the channel server.

The selected advertisement, advertisement A, can be provided to client 860 as indicated by the solid arrow connecting advertisement A with the client. As indicated by arrow 870, a feedback loop in the form of the client's response to advertisement A may be used to update session information of the client's profile, whereby the process may be repeated for the subsequent selection and delivery of targeted content.

FIG. 9 shows a schematic depiction of an example heuristics based approach that may be used by the ISP server system to distinguish the network activity of each of their clients to enable the creation of client specific profiles based on their respective network activity. As described with reference to at least the second and third embodiments, a replicated version of the original data stream can be analyzed by the profiler. FIG. 9 shows an example of this replicated data stream indicated generally at 900 as it may be received by the profiler of the ISP server system. In the example provided by FIG. 9, this data stream can include a plurality of different data groups or quanta indicated at 910-920 that may be received by the profiler over a period of time as indicated along the horizontal axis.

Information associated with each data group may include the IP address of the client, the direction of the data stream (e.g. to the client or from the client), the client-agent (e.g. the client operating system and/or browser), and derivative information indicated generally in FIG. 9 as content. Note that this derivative information or content of each data group can include keywords, URLs, and/or search terms associated with the HTTP portion of the data.

As shown in FIG. 9, a first data group of data stream 900 indicated at 910 can include information such as the IP address of a network client indicated for sake of explanation as “1”. Further, a direction of transmission may be identified by the profiler, which is indicated in this example as “from”, referring to data was transmitted from a client of the ISP to another network location. Data group 910 can also include client-agent information denoted in this example for sake of discussion as “1”. The client-agent information can include an indication of the browser and/or operating system of the client, among other client specific information. Further still, data group 910 can also indicate various derivative information denoted in this example as content as indicated by “1”. It should be appreciated that the examples described with regards to FIG. 9 have been provided for purposes of discussion and that the values indicated for the IP address, client-agent, or content fields have been simplified for ease of explanation. Each of the above elements that are indicated by the data may be identified by the profiler. For example, the profiler can analyze the HTTP data for the derivative information, client-agent information, and/or an IP address, among other suitable information.

At a later time, a second group of data 912 of data stream 900 may be received by the profiler. Data group 912 indicates a different IP address than data group 910 and further includes different content. As one example, data group 910 can include a data request from a first client and may contain content that includes a first URL; and data group 912 can include a data request from a second client containing content that includes a second URL.

As the profiler receives data groups 910 and 912, which indicate different IP addresses, the ISP server group can create and store profiles for each of the clients attributable to data groups 910 and 912. For example, the profiler can create a profile for each unique client that is identified from the replicated data stream. As indicated at 940, a group of pre-anonymized client profiles may be created responsive to receipt of data groups 910 and 912 as shown at 932 and 934. The profiler can store information such as the IP address, client-agent information, and/or derivative information in a client specific profile based on the activity of each unique client that is identified from the data stream by the profiler.

For example, data group 910 can be read by the profiler, whereby a profile 932 can be created and assigned a temporary UID indicated in this example by “1234”. As can be appreciated from the example of FIG. 9, the IP address, client agent, and content associated with data group 910 may been stored as profile 932 in memory at the ISP server system under a temporary UID. Similarly, a profile 934 has been created and stored responsive to data group 912 being received by the profiler, which includes a different temporary UID indicated as “1235” and further includes the IP address, client-agent, and content associated with data group 912.

As indicated at 914, the profiler server can receive a third data group including various information such as derivative information or content “3” being provided to IP address “1” which is utilizing a user-agent indicated as “1”. The profiler server, upon receiving data group 914, can compare the information contained within the data group to information stored in the profile to determine whether a profile for the client has already been created. For example, the profiler server can match the IP address and other information associated with data group 914, such as client-agent or content, to profile 932, where the additional derivative information indicated as content “3” may be stored at profile 932 in addition to the derivative information including content “1” that was previously obtained from data group 910. In this way, the ISP server group can create and update a profile for each network client.

Continuing with FIG. 9, other data groups may be received by the profiler server group including data groups 916, 918, and 920. As indicated by data group 916, a new IP address indicated as “3” has been identified by the profiler server for a client that is utilizing client-agent “2” and further includes derivative information indicated as content “2”. In response to receiving the new IP address, the profiler server can create a new profile as indicated at 936.

Data group 918 illustrates an example of how the profiler can distinguish multiple clients or client users from each other, even when they utilize a common IP address. For example, responsive to receiving data group 918, the profiler server can compare the information associated with the data group with the various profiles stored in memory. In this particular example, profile 934 has already been created for a client of IP address “2”. However, the profiler may create a new profile indicated at 938 when the client-agent of data group 918 is sufficiently different from the client-agent of profile 934. One advantage of the heuristics based approach is that multiple clients or client users communicating with the network via a common IP address can be distinguished by the profiler by utilizing additional information contained within the data group, including the client-agent, for example. Further, as another example, the derivative information associated with data group 918 (indicated as content “4”) can be sufficiently different from the derivative information associated with data group 912, that the profiler can declare that two separate clients are interacting with the network via a common IP address.

Further still, as indicated at 922, a RADIUS can provide an indication to the profiler of an initialization of a new session by a client. For example, the profiler can receive an input from the RADIUS that enables the profiler to distinguish the activity of a first client (data group 912) from the activity of a second client (data group 918) even when they use a common IP address (e.g. IP address “2”). In some examples, a previously created profile (e.g. profile 934) may be deleted or discarded from the profiler's memory and a new profile may be created (e.g. profile 938) responsive to an indication that a new client has initiated a new session utilizing the same IP address as a previously detected client. Alternatively, the previously created profile (e.g. profile 934) may be retained in memory, whereby additional updates may be performed responsive to additional network activity by the client as indicated at 920. Thus, it can be appreciated that the profiler can use a variety of information to distinguish different clients or client users by way of the heuristics based approach, thereby enabling a separate profile to be created and periodically updated for each unique client responsive to their network activity.

The pre-anonymized client profiles stored, for example, in a first database at the profiler, as indicated at 940, can be anonymized and stored in a second database indicated at 960 by removing non-anonymous information indicative of the client's identity. For example, with regards to the second embodiment, the profiler can be utilized by the ISP server system to create the temporary profile and provide the anonymization function described with reference to the anonymizer of first and third embodiments. With the first and third embodiments, a separate anonymizer can be used to store the anonymized client profiles.

For example, profiles 932, 934, 936, and 938 can be anonymized by discarding non-anonymous information associated with the client such as the IP address indicated at 952, 954, 956, and 958, respectively. In some examples, a permanent UID may be assigned to each of the profiles. For example, anonymized profile 952 can be assigned a permanent UID “2345”. Furthermore, in some examples, the temporary UID may also be discarded from each of the anonymized profiles. In this way, the identities of the various clients responsible for the profile information stored in memory at the ISP server system and/or central channel server can remain anonymous even as the ISP server system continues to periodically create, store, and update these client profiles for use in guiding content delivery to the network clients.

It will be appreciated that the embodiments and method implementations disclosed herein are exemplary in nature, and that these specific examples are not to be considered in a limiting sense, because numerous variations are possible. The subject matter of the present disclosure includes all novel and nonobvious combinations and subcombinations of the various configurations and method implementations, and other features, functions, and/or properties disclosed herein. Claims may be presented that particularly point out certain combinations and subcombinations regarded as novel and nonobvious. Such claims may refer to “an” element or “a first” element or the equivalent thereof. Such claims should be understood to include incorporation of one or more such elements, neither requiring nor excluding two or more such elements. Other combinations and subcombinations of the disclosed features, functions, elements, and/or properties may be claimed through amendment of the present claims or through presentation of new claims in this or a related application. Such claims, whether broader, narrower, equal, or different in scope to the original claims, also are regarded as included within the subject matter of the present disclosure.

We claim:

1. A system for providing targeted content to a client of a network, comprising:
a replication device configured to replicate a data stream transmitted between at least one network server and a plurality of clients of the network via a service provider;
a server system configured to:
(i) receive the replicated data stream from the replication device;
(ii) for each of the plurality of clients, identify a portion of the replicated data stream attributable to the client and update a profile of the client based on information derived from the identified portion of the replicated data stream; and
(iii) store a plurality of channels, wherein each channel includes associated triggering criteria and further indicates content;
a channel selection engine configured to receive a request from the data stream for the content to be delivered to a select client of the plurality of clients, and select a channel by comparing the updated profile of the select client to the triggering criteria of each of the plurality of channels; and
a forwarding module configured to forward a request for the content indicated by the selected channel to a content provider, wherein the content provider is configured to provide the content requested by the forwarding module to the select client.

2. The system of claim 1, wherein the content includes an advertisement.

3. The system of claim 1, wherein the replication device includes a network tap and wherein the content request is provided to the channel selection engine via a switching device.

4. The system of claim 1, wherein the information derived from the identified portion of the replicated data stream includes keywords contained in the hypertext transfer protocol portion of the replicated data stream.

5. The system of claim 1, wherein the information derived from the identified portion of the replicated data stream includes a universal resource locator associated with the hypertext transfer protocol portion of the replicated data stream.

6. The system of claim 1, the information derived from the identified portion of the replicated data stream includes at least a search term of a search query initiated by the client.

7. The system of claim 1, wherein the profile of the client is stored at the server system without reference to a non-anonymous identifier associated with the client.

8. The system of claim 1, wherein the server system is further configured to, for each of the plurality of clients, discard an IP address of the client from their respective profile.

9. The system of claim 1 further comprising, a binding module configured to send a unique identification tag to the select client in addition to the content provided to the select client by the content provider, wherein the unique identification tag is configured to transmit a unique identifier with at least some data requests subsequently transmitted by the select client after the unique identification tag is received at the select client.

10. The system of claim 9, wherein the unique identifier is transmitted as a hypertext transfer protocol cookie with a data request transmitted by the select client.

11. The system of claim 1, wherein the content provider resides at the service provider.

12. The system of claim 1, wherein the content provider is external to the service provider and wherein the forwarding module is further configured to forward the content request to the content provider via the network.

13. The system of claim 1, wherein the content includes an interstitial advertisement that is provided to the client by the content provider as the client is directed between different domains.

14. A method of selecting targeted content for delivery to a client of a wide area computer network, the method comprising:
replicating a data stream transmitted between a network server and a plurality of network clients;
attributing a portion of the replicated data stream to a particular client of the plurality of clients;
storing information derived from the portion of the replicated data stream in a client profile;
receiving a content request from the particular client,
retrieving the client profile based on a comparison of the content request received at the server system and a replicated content request provided to the server system via the network tap;
selecting content to be delivered to the particular client from a group of content based on the client profile; and
forwarding a request for the selected content to a content provider, wherein the content provider is configured to provide the selected content to the particular client indicated by the second unique identifier.

15. The method of claim 14, wherein the content includes an advertisement.

16. The method of claim 14, wherein the information derived from the portion of the replicated data stream includes keywords displayed on a webpage at the client or a universal resource locator associated with the webpage displayed at the client.

17. The method of claim 14, wherein the information derived from the portion of the replicated data stream includes at least a search term of a search query initiated by the client.

18. A method, comprising:
at a switching device, intercepting a data stream directed to a network server from a network client and redirecting a first hypertext transfer protocol portion of the data stream to a server system; and
returning a unique identification tag to the network client from the server system via the switching device, wherein the unique identification tag is configured to include a unique identifier with a hypertext transfer protocol data stream subsequently transmitted by the client;
at the switching device, intercepting the data stream directed to the network server from the client and replicating a second hypertext transfer protocol portion of the data stream including the unique identifier, and passing the data stream to the network server;
at the server system, receiving the replicated data and the unique identifier from the switching device, and storing information derived from the replicated data with the unique identifier in memory;
selecting an advertisement from a plurality of advertisements based on the derivative information stored in memory for the unique identifier responsive to an advertisement request received from the network client; and
providing the selected advertisement to the network client indicated by the unique identifier.

19. The method of claim 18, wherein the advertisement request is initiated by an advertisement tag associated with a webpage provided to the client.

20. The method of claim 18, wherein the derivative information includes keywords contained in the hypertext transfer protocol portion of the data stream.

21. The method of claim 18, wherein the derivative information includes a universal resource locator contained in the hypertext transfer protocol portion of the data stream.

22. The method of claim 18, wherein the derivative information includes a search term contained in the hypertext transfer protocol portion of the data stream of a search query initiated by the client.

23. The method of claim 18, wherein the unique identification tag is returned to the network client as a cookie.

24. The method of claim 18, further comprising, at the switching device, passing a non-hypertext transfer protocol portion of said data stream to the network server via a wide area network without redirecting the non-hypertext transfer protocol portion of said data stream to the server system.

25. A system implemented at a service provider for acquiring client activity on a wide area network, comprising:
a switching device configured to intercept a data stream directed to a network server from a network client and redirect a first hypertext transfer protocol portion of the data stream; and
a server system configured to receive the redirected first hypertext transfer protocol portion of the data stream and return a unique identification tag to the network client via the switching device, wherein the unique identification tag upon reception by the client is configured to transmit a unique identifier with subsequent hypertext transfer protocol data provided by the client;
wherein the switching device is further configured to replicate a second hypertext transfer protocol portion of the data stream including the transmitted unique identifier, and pass the data stream to the network server, and wherein the server is further configured to store information derived from the replicated data with the unique identifier.
